(19) United States
(12) Patent Application Publication
(10) Pub. No.: US 2024/0211352 A1
(43) Pub. Date: Jun. 27, 2024

(54) TAMPER DETECTECTION MEMORY SAVE WITH DELAY

(71) Applicants: Alan Arnold et al., Durham, NC (US); Yusuke Taira, Kanagawa (JP); Takashi Sugawara, Kanagawa (JP); Bruce (Guo jun) Hua, Shenzhen (CN)

(72) Inventors: Alan Arnold et al., Durham, NC (US); Yusuke Taira, Kanagawa (JP); Takashi Sugawara, Kanagawa (JP); Bruce (Guo jun) Hua, Shenzhen (CN)

(21) Appl. No.: 18/556,592

(22) PCT Filed: Apr. 20, 2021
(86) PCT No.: PCT/CN2021/088479

§ 371 Date: Oct. 20, 2023

(51) Int. Cl. G06F 11/14; G06F 21/86

(52) U.S. Cl. CPC G06F 11/1441; G06F 21/86

(57) ABSTRACT

A computer implemented method and system includes receiving a tamper notification responsive to improper opening of a device enclosure, starting a delay time timer in response to receiving the tamper signal, initiating saving of volatile memory data in a storage device to non-volatile storage, providing a power down notification signal to a device power controller in response to the timer reaching a predetermined state, and powering down the device in response to the power down notification signal.

### BACKGROUND

It is sometimes desirable to disable a personal computer when the covers are opened by non-authorized personnel. One way to do this is to have a tamper detection switch trigger a power FET which will turn off the system power. However, any user data in the system storage device's volatile write cache will be lost, and the storage device's critical metadata structures may also be damaged. Therefore, the storage device must be permitted sufficient time to flush the write cache and save its metadata structures.

One method to provide time for the cache flush utilizes a battery or power back-up capacitors either on an internal system board or on the storage device itself. However, this adds cost and additional components failure opportunities.

### SUMMARY

A computer implemented method and system includes receiving a tamper notification responsive to improper opening of a device enclosure, starting a delay time timer in response to receiving the tamper signal, initiating saving of volatile memory data in a storage device to non-volatile storage, providing a power down notification signal to a device power controller in response to the timer reaching a predetermined state, and powering down the device in response to the power down notification signal.

### BRIEF DESCRIPTION OF THE DRAWINGS

FIGS. 1A and 1B are block perspective diagram of a device that includes a case and at least one panel in two different states according to an example embodiment.

FIG. 2 is a block schematic diagram of a system capable of saving data in volatile memory of a device in response to tamper detection or intentional powering down the device according to an example embodiment.

FIG. 3 is a block schematic diagram of an alternative system capable of saving data in volatile memory of a device in response to tamper detection or intentional powering down the device according to an example embodiment.

FIG. 4 is a flowchart illustrating a computer or machine implemented method of saving data in volatile memory in response to detection of tampering with an electronics case according to an example embodiment.

FIG. 5 is a block schematic diagram of an alternative system capable of saving data in volatile memory of a device in response to tamper detection or intentional powering down the device.

FIG. 6 is a block schematic diagram of a computer system to implement one or more example embodiments.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, logical and electrical changes may be made without departing from the scope of the present invention. The following description of example embodiments is, therefore, not to be taken in a limited sense, and the scope of the present invention is defined by the appended claims.

The functions or algorithms described herein may be implemented in software in one embodiment. The software may consist of computer executable instructions stored on computer readable media or a computer readable storage device such as one or more non-transitory memories or other type of hardware-based storage devices, either local or networked. Further, such functions correspond to modules, which may be software, hardware, firmware, or any combination thereof. Multiple functions may be performed in one or more modules as desired, and the embodiments described are merely examples. The software may be executed on a digital signal processor, ASIC, microprocessor, or other type of processor operating on a computer system, such as a personal computer, server, or other computer system, turning such computer system into a specifically programmed machine.

The functionality can be configured to perform an operation using, for instance, software, hardware, firmware, or the like. For example, the phrase “configured to” can refer to a logic circuit structure of a hardware element that is to implement the associated functionality. The phrase “configured to” can also refer to a logic circuit structure of a hardware element that is to implement the coding design of associated functionality of firmware or software. The term “module” refers to a structural element that can be implemented using any suitable hardware (e.g., a processor, among others), software (e.g., an application, among others), firmware, or any combination of hardware, software, and firmware. The term, “logic” encompasses any functionality for performing a task. For instance, each operation illustrated in the flowcharts corresponds to logic for performing that operation. An operation can be performed using, software, hardware, firmware, or the like. The terms, “component,” “system,” and the like may refer to computer-related entities, hardware, and software in execution, firmware, or combination thereof. A component may be a process running on a processor, an object, an executable, a program, a function, a subroutine, a computer, or a combination of software and hardware. The term, “processor,” may refer to a hardware component, such as a processing unit of a computer system.

Furthermore, the claimed subject matter may be implemented as a method, apparatus, or article of manufacture using standard programming and engineering techniques to produce software, firmware, hardware, or any combination thereof to control a computing device to implement the disclosed subject matter. The term, “article of manufacture,” as used herein is intended to encompass a computer program accessible from any computer-readable storage device or media. Computer-readable storage media can include, but are not limited to, magnetic storage devices, e.g., hard disk, floppy disk, magnetic strips, optical disk, compact disk (CD), digital versatile disk (DVD), smart cards, flash memory devices, among others. In contrast, computer-readable media, i.e., not storage media, may additionally include communication media such as transmission media for wireless signals and the like.

An electronic device includes a tamper switch that changes state in response to an authorized or unauthorized opening of an electronic device cover. The state of the tamper switch changes from a reference voltage state corresponding to a closed cover, to an open circuit or zero voltage state upon separation of the cover from a case of the electronic device. The zero-voltage state is detected, triggering both a power loss notification being sent to a storage controller, and initiation of a delay period to a device power controller. Alternatively, a change of voltage state from any level to another level may be used to initiate notifications and the delay period in further embodiments.

The power loss notification, indicative of an impending power loss, results in the storage controller saving data residing in volatile storage to non-volatile storage. The volatile storage is a type of storage, such as dynamic random-access memory that retains stored data so long as power is provided to the non-volatile storage. Such storage may be used as a write cache that stores data that is likely to have been recently modified as well as metadata identifying the state of executing software. The loss of such data is not desired. The saving of data from the volatile storage to non-volatile storage that retains data without power being provided, can take time depending on how much data is to be saved.

Power for components of the electronic device may be controlled by a power controller. The initiation of the delay period results in a delay before a power off signal is provided to the power controller. The amount of delay may be set at manufacture to be consistent with delays associated with holding down a power button on the device or may be programmable and set to a delay consistent with a period that ensures all data will be saved. Four seconds is a commonly used value for both time periods. The delay may also be terminated by a signal from the storage device such as the standard M.2 PLA #control signal indicating it has completed saving the data in the volatile memory. The power controller will cut power to the device components, including the storage controller in response to expiration of the delay period.

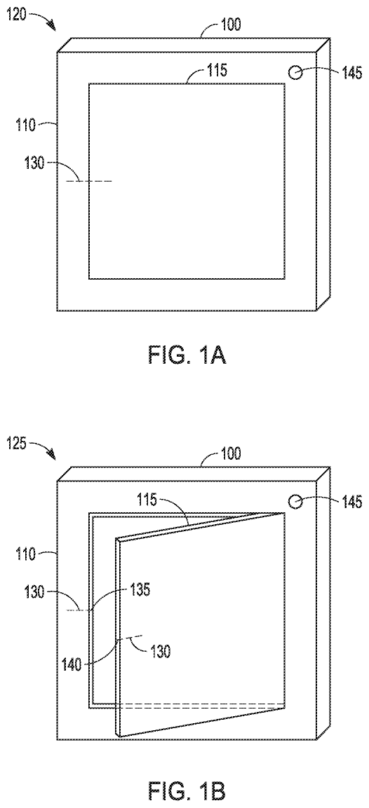

FIGS. 1A and 1B are block perspective diagram of a device 100 that includes a case 110 and at least one panel 115 in two different states. The device 100 may be a personal computer, laptop, smart phone, touchpad, or other electronic device for which tamper protection is desired. The panel 115 provides access to electronics internal to the case 110 of the device 100. In some cases, the panel 115 is not meant to be removed by a user while the device is operating with power being supplied to the device electronics.

Device 100 is shown in two states. In a first state at 120 in FIG. 1A, device 100 is shown with the panel 115 closed. In a second state at 125 in FIG. 1B, device 100 is shown with the panel 115 at least in a partially opened state, potentially exposing some of the electronics. A tamper detection switch 130 is coupled to detect an at least partially open state of the panel 115.

In the first state at 120, tamper detection switch 130 is shown in a closed state. In the second state at 125, with the panel at least partially open, the tamper detection switch 130 is shown in an open state. The open state results in the device 100 being powered down with a delay time sufficient to allow saving of data stored in volatile storage. The tamper detection switch may be a magnetic reed type of switch, a proximity detector, a simple pair of mating electrical contacts, one on the case as shown at 135 and one on the panel as illustrated at 140. The contacts separate upon opening of the panel, resulting in an open circuit.

Device 100 may also include a power switch 145. In various examples, power switch 145 is used to turn power on and off. Power switch 145 may be used to turn on the device 100 from a power off state or may be used in different manners to cause the device 100 to enter a sleep mode or to power off the device 100. If the power button 145 is held depressed for a short time period, less that a predetermined time such as four seconds, the device 100 may enter a sleep mode. If the power button 145 is held down longer than the predetermined time, the device will be instructed to power down.

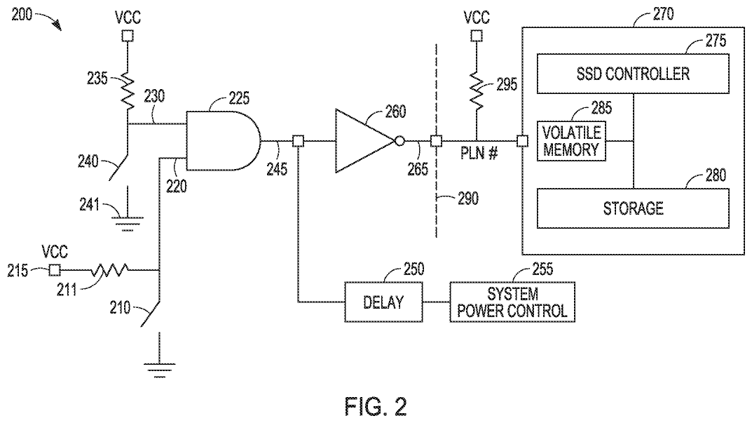

FIG. 2 is a block schematic diagram of a system 200 capable of saving data in volatile memory of a device in response to tamper detection or intentional powering down the device. System 200 includes a tamper switch 210 coupled to detect at least partial opening of a panel on a device case as described with reference to FIG. 1. In one embodiment, the tamper switch 210 is coupled to a reference voltage 215 such as V_{CC} through a pull-up resistor 211. System 200 may also include a system power button 240, also coupled to a reference voltage, such as V_{CC}, through a pull-up resistor 235.

Tamper switch 210 is coupled to a first input 220 of a logic device, such as OR gate 225, providing a normally high logic level prior to detection of tampering, and a low voltage level, such as zero, corresponding to an open state. The low voltage level comprises a tamper notification triggered in response to at least partial uncoupling of the panel from the electronics case. Note that for other types of tamper switches, the voltage levels may be reversed or be converted from analog levels to digital levels for use with logic circuitry.

System power switch 240 may be coupled to a second input 230 of OR gate 225 such as with a pull up resistor 235 coupled to a reference voltage such as V_{CC} on one contact and coupled to ground 241 on the other. Thus, when power switch 240 is closed, the voltage provided to second input 230 is at a zero or ground level, corresponding to logic zero. Opening power switch 240 by pressing or otherwise activating system power button 215 causes the second input to increase to the reference voltage corresponding to a logic one or high level, corresponding to a power down signal.

OR gate 225 performs an OR function, generating an output comprising an indication of a tamper notification at 245. The indication of the tamper notification is provided to a delay timer 250 coupled to the output 245. The delay timer may have a set delay value, such as four seconds or may be programmed to a different value as desired. Upon expiration of the delay value, the delay timer informs a system power controller 255 to power down the system 200. In various embodiments, the delay timer may be part of the system power controller 255 and may simply be a count down timer or other means for delaying action on a received signal. The amount of time may be fixed or may be programmable. The programmable amount of time may be based on a longest time needed for completing specified operations, such as transfer of cache data to storage for a particular storage device and saving of critical metadata such as a solid-state drive's Flash Translation Layer tables, or an anticipated amount of time needed for transfer of a known or estimated amount of data.

The indication of a tamper notification at 245 also represents the power down signal and is provided to a buffer circuit 260 for generation of a power loss notification signal 265 that is provided to a storage device 270 that includes a storage controller 275, a non-volatile storage 280 and a volatile memory 285. Buffer circuit 260 may be an open drain field effect transistor for example and provides a stable output logic signal that may be provided to multiple devices. In one embodiment, the power loss notification signal 265 is the M.2 interface 290 standard PLN #signal. A pullup resistor 295, such as a 10 K ohm resistor, may also be coupled to ensure the loss notification signal 265 is at a proper voltage level.

In one embodiment, storage device 270 comprises a solid-state storage device. Non-volatile storage 280 comprises semiconductor-based storage in one embodiment with volatile memory 285 is used as a write cache and may also contain metadata regarding operations being performed at the time the storage device 270 receives the loss notification signal 265 at the storage controller 275. Upon receipt of the power loss notification signal 265, the storage controller 275 initiates saving of data by transferring data from volatile memory 285 to non-volatile storage 280 and completes the transfer of data prior to expiration of the delay provided by delay timer 250 and corresponding removal of power from system 200.

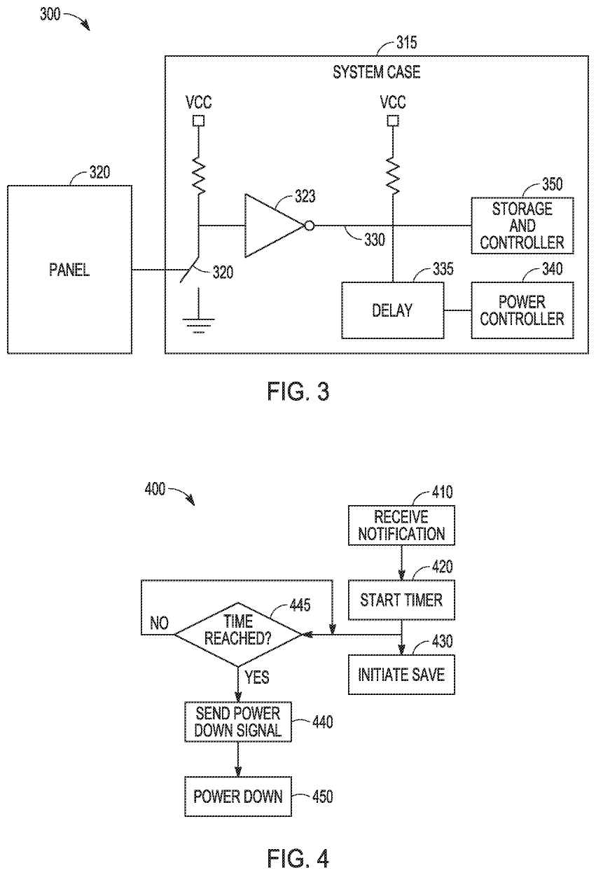

FIG. 3 is a block schematic diagram of an alternative system 300 capable of saving data in volatile memory of a device in response to tamper detection. A panel 310 is shown removed from a system case 315 causing a switch 320 to open. Switch 320 is coupled to an inverter 323. Opening of the switch 320 causes the voltage input to the inverter 323 to be pulled to a logical high level, triggering a low output at 330. The output 330 is coupled to a delay circuit 335, which delays a signal sent to a coupled power controller 340 to power down the system 300. The output 330 is also coupled to a storage device 350 which contains a storage controller to initiate and perform saving of data from volatile memory to non-volatile memory of the storage device.

In various embodiments herein the storage device may be solid-state storage devices or any other type of storage device such as a disk drive, compact disc, tape, or other storage device that includes volatile memory which may be used to cache data and also includes non-volatile storage. The cached data is written to the non-volatile storage in response to receiving the output 330, which may be a power loss notification signal such as the standard M.2 PLN#control signal.

FIG. 4 is a flowchart illustrating a computer or machine implemented method 400 of saving data in volatile memory in response to detection of tampering with an electronics case. Method 4 begins by receiving a tamper notification at operation 410 responsive to improper opening of a device enclosure. At operation 420, a delay time timer is started in response to receiving the tamper signal. Operation 430 initiates saving of volatile memory data to non-volatile storage of a storage device and saving of critical metadata.

In one embodiment, the time it takes to reach the predetermined state of the timer comprises a delay time that provides sufficient time for saving of volatile memory data to non-volatile storage to complete. A delay time of four seconds is sufficient for most current storage devices, but other programmable values may be alternatively be used.

A power down notification signal is provided at operation 440 to a device power controller in response to the timer reaching a predetermined state as illustrated at decision operation 445. At operation 450 the device is powered down in response to the power down notification signal.

In further embodiments, the timer may be started in response to either the receiving the tamper signal, receiving an indication that a power button is being depressed, or receiving both the tamper signal and indication that the power button is being depressed. The predetermined state of the timer may be different in response to the tamper signal being received or receiving an indication that the power button is being depressed.

In one embodiment, the volatile memory is a write cache and the storage device is a solid-state storage device. The saving of volatile memory data is controlled by a solid-state storage device controller. Initiating saving of volatile memory may include generating a power loss notification signal and providing the power loss notification signal to the solid-state storage device controller. Saving of the volatile memory data should be completed prior to the time reaching the predetermined state. The volatile memory data includes cache write data and metadata, which may include data related to writes and program status.

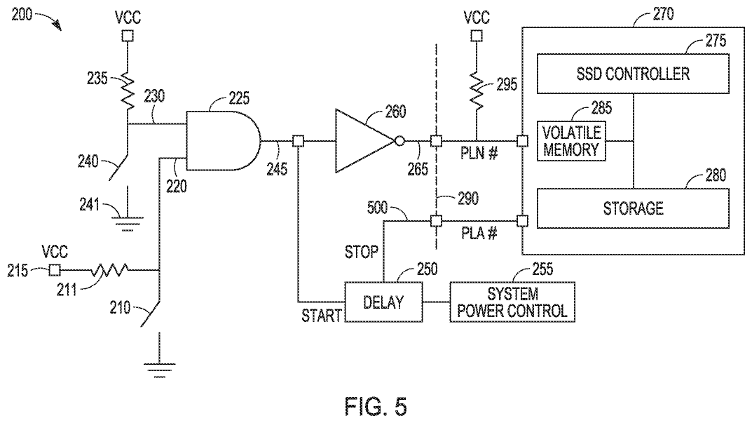

FIG. 5 is a block schematic diagram of an alternative system 500 capable of saving data in volatile memory of a device in response to tamper detection or intentional powering down the device. System 500 includes many components that are similar to those in FIG. 2. The same reference numbers are used for such components. System 500 uses an M.2 standard power loss notification as tamper notification 245 to start the delay 250. At the end of the delay, a Power Loss Acknowledge signal at 500 such as the M.2 standard PLA#signal is provided to storage device 270.

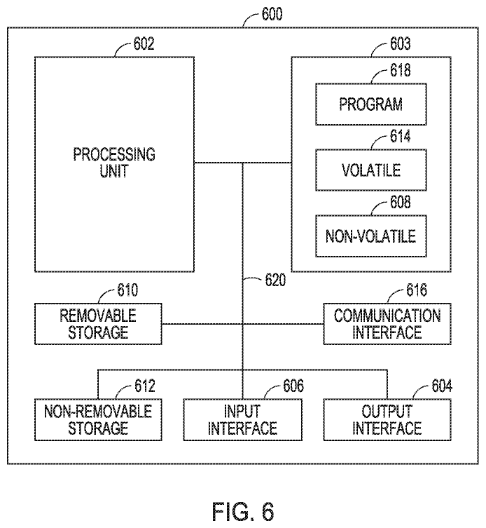

FIG. 6 is a block schematic diagram of a computer system 600 to implement one or more of the storage devices and controllers and for performing methods and algorithms according to example embodiments. All components need not be used in various embodiments.

One example computing device in the form of a computer 600 may include a processing unit 602, memory 603, removable storage 610, and non-removable storage 612. Although the example computing device is illustrated and described as computer 600, the computing device may be in different forms in different embodiments. For example, the computing device may instead be a smartphone, a tablet, smartwatch, smart storage device (SSD), or other computing device including the same or similar elements as illustrated and described with regard to FIG. 6. Devices, such as smartphones, tablets, and smartwatches, are generally collectively referred to as mobile devices or user equipment.

Although the various data storage elements are illustrated as part of the computer 600, the storage may also or alternatively include cloud-based storage accessible via a network, such as the Internet or server-based storage. Note also that an SSD may include a processor on which the parser may be run, allowing transfer of parsed, filtered data through I/O channels between the SSD and main memory.

Memory 603 may include volatile memory 614 and non-volatile memory 608. Computer 600 may include—or have access to a computing environment that includes—a variety of computer-readable media, such as volatile memory 614 and non-volatile memory 608, removable storage 610 and non-removable storage 612. Computer storage includes random access memory (RAM), read only memory (ROM), erasable programmable read-only memory (EPROM) or electrically erasable programmable read-only memory (EEPROM), flash memory or other memory technologies, a solid-state storage device (SSD), compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions.

Computer 600 may include or have access to a computing environment that includes input interface 606, output interface 604, and a communication interface 616. Output interface 604 may include a display device, such as a touchscreen, that also may serve as an input device. The input interface 606 may include one or more of a touchscreen, touchpad, mouse, keyboard, camera, one or more device-specific buttons, one or more sensors integrated within or coupled via wired or wireless data connections to the computer 600, and other input devices. The computer may operate in a networked environment using a communication connection to connect to one or more remote computers, such as database servers. The remote computer may include a personal computer (PC), server, router, network PC, a peer device or other common data flow network switch, or the like. The communication connection may include a Local Area Network (LAN), a Wide Area Network (WAN), cellular, Wi-Fi, Bluetooth, or other networks. According to one embodiment, the various components of computer 600 are connected with a system bus 620.

Computer-readable instructions stored on a computer-readable medium are executable by the processing unit 602 of the computer 600, such as a program 618. The program 618 in some embodiments comprises software to implement one or more methods described herein. A hard drive, CD-ROM, and RAM are some examples of articles including a non-transitory computer-readable medium such as a storage device. The terms computer-readable medium, machine readable medium, and storage device do not include carrier waves to the extent carrier waves are deemed too transitory. Storage can also include networked storage, such as a storage area network (SAN). Computer program 618 along with the workspace manager 622 may be used to cause processing unit 602 to perform one or more methods or algorithms described herein.

### Examples

1. A computer implemented method includes receiving a tamper notification responsive to improper opening of a device enclosure, starting a delay time timer in response to receiving the tamper signal, initiating saving of volatile memory data in a storage device to non-volatile storage, providing a power down notification signal to a device power controller in response to the timer reaching a predetermined state, and powering down the device in response to the power down notification signal.

2. The method of example 1 wherein the time it takes to reach the predetermined state of the timer comprises a delay time that provides sufficient time for saving of volatile memory data to non-volatile storage to complete.

3. The method of example 2 wherein the delay time is 4 seconds.

4. The method of any of examples 1-3 wherein the timer is started in response to either the receiving the tamper signal, receiving an indication that a power button is being depressed, or receiving both the tamper signal and indication that the power button is being depressed.

5. The method of example 4 wherein the predetermined state of the timer is different in response to the tamper signal being received or receiving an indication that the power button is being depressed.

6. The method of any of examples 1-5 wherein the volatile memory comprises a write cache.

7. The method of example 6 wherein the storage device comprises a solid-state storage device and the saving of volatile memory data is controlled by a solid-state storage device controller.

8. The method of example 7 wherein initiating saving of volatile memory data includes generating a power loss notification signal and providing the power loss notification signal to the solid-state storage device controller.

9. The method of example 8 and further comprising completing saving of the volatile memory data prior to the time reaching the predetermined state and wherein the volatile memory data includes cache write data and metadata.

10. A device includes a processor and a memory device coupled to the processor and having a program stored thereon for execution by the processor to perform operations. The operations include receiving a tamper notification responsive to improper opening of a device enclosure, starting a delay time timer in response to receiving the tamper signal, initiating saving of volatile memory data in a storage device to non-volatile storage, providing a power down notification signal to a device power controller in response to the timer reaching a predetermined state, and powering down the device in response to the power down notification signal.

11. The device of example 10 wherein the time it takes to reach the predetermined state of the timer comprises a delay time that provides sufficient time for saving of volatile memory data to non-volatile storage to complete.

12. The device of example 11 wherein the delay time is 4 seconds.

13. The device of any of examples 10-12 wherein the timer is started in response to either the receiving the tamper signal, receiving an indication that a power button is being depressed, or receiving both the tamper signal and indication that the power button is being depressed.

14. The device of any of examples 10-13 wherein the volatile memory includes a write cache, wherein the storage device comprises a solid-state storage device and the saving of volatile memory data is controlled by a solid-state storage device controller. Initiating saving of volatile memory data includes generating a power loss notification signal and providing the power loss notification signal to the solid-state storage device controller.

15. An electronic device tamper detection system includes an electronics case for enclosing electronics of the electronic device, a panel coupled to the electronics case, a tamper switch supported by the electronics case and configured to trigger a tamper notification in response to at least partial uncoupling of the panel from the electronics case, a delay timer coupled to receive an indication of the tamper notification, a power controller coupled to power down the electronic device following a delay provided by the delay timer, and a storage device controller coupled to initiate saving of volatile memory data in response to the tamper notification.

16. The system of example 15 and further including a system power button and OR logic circuitry to receive a power down signal and the tamper notification and provide an output comprising the indication of the tamper notification.

17. The system of example 16 and further including a buffer coupled to receive the indication of the tamper notification from the OR logic circuitry, generate a power loss notification signal, and provide the power loss notification signal to the storage device controller to initiate saving of volatile memory data.

18. The system of example 17 wherein the OR logic circuitry output includes an indication of activation of the system power button.

19. The system of any of examples 15-18 and further including a system power button coupled to provide a power down signal to the delay timer and the storage device controller.

20. The system of example 19 wherein the delay timer provides a first delay in response to the indication of the tamper notification and a second delay in response to the power down signal.

Although a few embodiments have been described in detail above, other modifications are possible. For example, the logic flows depicted in the figures do not require the particular order shown, or sequential order, to achieve desirable results. Other steps may be provided, or steps may be eliminated, from the described flows, and other components may be added to, or removed from, the described systems. Other embodiments may be within the scope of the following claims.

1. A computer implemented method comprising:
receiving a tamper notification responsive to improper opening of a device enclosure;
starting a delay time timer in response to receiving the tamper signal;
initiating saving of volatile memory data in a storage device to non-volatile storage;
providing a power down notification signal to a device power controller in response to the timer reaching a predetermined state; and
powering down the device in response to the power down notification signal.

2. The method of claim 1 wherein the time it takes to reach the predetermined state of the timer comprises a delay time that provides sufficient time for saving of volatile memory data to non-volatile storage to complete.

3. The method of claim 2 wherein the delay time is 4 seconds.

4. The method of claim 1 wherein the timer is started in response to either the receiving the tamper signal, receiving an indication that a power button is being depressed, or receiving both the tamper signal and indication that the power button is being depressed.

5. The method of claim 4 wherein the predetermined state of the timer is different in response to the tamper signal being received or receiving an indication that the power button is being depressed.

6. The method of claim 1 wherein the volatile memory comprises a write cache.

7. The method of claim 6 wherein the storage device comprises a solid-state storage device and the saving of volatile memory data is controlled by a solid-state storage device controller.

8. The method of claim 7 wherein initiating saving of volatile memory data comprises:
generating a power loss notification signal; and
providing the power loss notification signal to the solid-state storage device controller.

9. The method of claim 8 and further comprising completing saving of the volatile memory data prior to the time reaching the predetermined state and wherein the volatile memory data includes cache write data and metadata.

10. A device comprising:
a processor; and
a memory device coupled to the processor and having a program stored thereon for execution by the processor to perform operations comprising:
receiving a tamper notification responsive to improper opening of a device enclosure;
starting a delay time timer in response to receiving the tamper signal;
initiating saving of volatile memory data in a storage device to non-volatile storage;
providing a power down notification signal to a device power controller in response to the timer reaching a predetermined state; and
powering down the device in response to the power down notification signal.

11. The device of claim 10 wherein the time it takes to reach the predetermined state of the timer comprises a delay time that provides sufficient time for saving of volatile memory data to non-volatile storage to complete.

12. The device of claim 11 wherein the delay time is 4 seconds.

13. The device of claim 10 wherein the timer is started in response to either the receiving the tamper signal, receiving an indication that a power button is being depressed, or receiving both the tamper signal and indication that the power button is being depressed.

14. The device of claim 10 wherein the volatile memory comprises a write cache, wherein the storage device comprises a solid-state storage device and the saving of volatile memory data is controlled by a solid-state storage device controller and wherein initiating saving of volatile memory data comprises:
generating a power loss notification signal; and
providing the power loss notification signal to the solid-state storage device controller.

15. An electronic device tamper detection system comprising:
an electronics case for enclosing electronics of the electronic device;
a panel coupled to the electronics case;
a tamper switch supported by the electronics case and configured to trigger a tamper notification in response to at least partial uncoupling of the panel from the electronics case;
a delay timer coupled to receive an indication of the tamper notification;
a power controller coupled to power down the electronic device following a delay provided by the delay timer; and
a storage device controller coupled to initiate saving of volatile memory data in response to the tamper notification.
